(19) United States
(12) Patent Application Publication
(10) Pub. No.: US 2008/0225146 A1
(43) Pub. Date: Sep. 18, 2008

(54) IMAGING APPARATUS AND IMAGE DATA RECORDING METHOD

(76) Inventor: Takashi Maki, Yokohama-shi (JP)

Correspondence Address: DICKSTEIN SHAPIRO LLP, 1825 EYE STREET NW, Washington, DC, 20006-5403, US

(21) Appl. No.: 12/048,905

(22) Filed: Mar. 14, 2008

(30) Foreign Application Priority Data
Mar. 16, 2007 (JP) 2007-069536

(51) Int. Cl. H04N 3/14

(52) U.S. Cl. 348/294; 348/E09.01

(57) ABSTRACT

An imaging apparatus, includes a photoelectrical conversion element with a rectangular light receiving surface, an image cut-out device that cuts out image data of a cut-out area of a square in which the number of pixels in the horizontal direction is the same as the number of pixels in the vertical direction from the image data of a rectangular image imported by the photoelectrical conversion element, and an image recording device which records the image data compressed by an image compression device or the image data cut out by the image cut-out device.

### PRIORITY CLAIM

This application claims priority from Japanese Patent Application No. 2007-069536, filed with the Japanese Patent Office on Mar. 16, 2007, the contents of which are incorporated herein by reference in their entirety.

### BACKGROUND OF THE INVENTION

1. Field of the Invention

The present invention relates to an imaging apparatus such as a digital camera, in particular, it relates to an imaging apparatus and an image data recording method that records a square image cut out from a rectangular image imported by using the imaging apparatus equipped with a photoelectric conversion element of a rectangular light receiving surface.

2. Description of the Related Art

An imaging apparatus such as a digital camera converts, by means of a photoelectric conversion element such as a charge-coupled device (CCD), image information of an optical quantity entering from a subject through an optical system into analog image information of an electrical quantity. It further converts the analog image information of an electrical quantity into digital image data having a gradation sequence and records the image data into a memory.

As one of such imaging apparatuses, an imaging apparatus is known having the function of changing an aspect ratio (a ratio between a horizontal length and a vertical length of an image) of a recording image by removing from a recording target a peripheral part of image data corresponding to a single screen portion imported from a subject when recording the image data and recording the remainder. The selectable aspect ratios are generally 3:2 (equal to a full-size image by a 35 mm film camera), 4:3 (equal to a TV broadcasting image by an NTSC method and so on), 16:9 (equal to a wide television broadcasting image) and so on. These aspect ratios have compatibility with aspect ratios used in television broadcasting or a film camera, wherein the aspect ratios are all in rectangular shapes.

A technology to select one from a plurality of rectangular aspect ratios has hitherto been provided. For example, when an aspect ratio of a light receiving surface of a photoelectric conversion element is 16:9, a conventional technology to select the aspect ratio of an image to be recorded from 3:2 and 4:3 is provided.

On the contrary, a conventional technology shown in JP2005-354577A utilizes a photoelectric conversion element (imaging element) having a square light receiving surface. The conventional technology shown in JP2005-354577A is described hereinbelow.

In the conventional technology, the light receiving surface of the imaging element is square. An image of a subject obtained by the imaging element can similarly be displayed in a full-screen mode on a square LCD (liquid crystal display) finder. For example, when “A4 horizontal” is selected, the aspect ratio of “1.41” is set, the through image of the subject is displayed on the LCD finder, and also a composition frame set with the aspect ratio of “1.41” is maximally displayed on the square LCD finder. In addition, the aspect ratio can be set by a user.

A light receiving surface S (refer to FIG. 10) of a general photoelectric conversion element (imaging element) has a horizontally long rectangular shape in which the number of pixels in a lateral direction is larger than the number of pixels in a longitudinal direction. When using such a rectangular photoelectric conversion element, an imaging optical system that images an imaging target image to the photoelectric conversion element is designed in conformity with the shape of the photoelectric conversion element. For example, as shown in FIG. 10, when the size of an image that ensures the required optical image quality is defined as an image circle C, the imaging optical system is designed so that diagonal lines of the light receiving surface S of the photoelectric conversion element fit within the image circle.

However, the imaging optical system generally has a property such that the light quantity of a peripheral portion is lacking in comparison to a center portion, thereby the resolution of the peripheral portion is low in comparison to the center portion and various optical properties of the peripheral portion and the center portion do not match. That is to say, regarding the image circle C, image quality is relatively inferior closer to the external side. Therefore, even when the light receiving surface S of the photoelectric conversion element fits within the internal side of the image circle C, the image quality of the four corner portions of the light receiving surface S of the photoelectric conversion element are inferior in comparison to the center portion. In addition, because the short sides of the rectangle, in comparison to the long sides, are situated farther away from the center of the image circle C, the image quality is inferior in the vicinity of the short sides of the light receiving surface S in comparison to the long sides.

In addition, regarding this point, in the case of the conventional technology shown in JP2005-354577A, it is not problematic because the light receiving surface S is a square. However, the conventional technology shown in JP2005-354577A assumes a square light receiving surface which is not common. On the other hand, other conventional technologies are proposed to cut out an image of a rectangular aspect ratio and because of image quality on both edge parts in a longitudinal direction of the above-described image or other reasons, other conventional technologies cannot meet the needs to record a square image. Furthermore, other conventional technologies cannot cut out a random position on a screen.

### SUMMARY OF THE INVENTION

The present invention is made with regard to the above problematic points, and it is an object of the present invention to provide an image data recording method and an imaging apparatus that is able to easily cut out and record a square image or cut out and record a square image at a specified position using a widely spread imaging apparatus with the photoelectrical conversion element of a rectangular light receiving surface.

To solve the above issues, a first aspect of the present invention relates to an imaging apparatus includes a photoelectrical conversion element with a rectangular light receiving surface, an image cut-out device that cuts out image data of a cut-out area of a square in which the number of pixels in the horizontal direction is the same as the number of pixels in the vertical direction from image data of a rectangular image imported by the photoelectrical conversion element, and an image recording device which records image data compressed by an image compression device or the image data cut out by the image cut-out device.

Advantageously, an image cut-out device automatically cuts out a center portion of an image imported by the photoelectrical conversion element.

Advantageously, an area selection device selects the cut-out area.

Advantageously, the imaging apparatus comprises a cut-out area display device that, as the area selection device, superimposedly displays a figure illustrating the cut-out area on a screen of photographed image before recording or a monitoring screen before photographing when selecting the cut-out area.

Advantageously, the imaging apparatus comprises a movement indication device that, as the area selection device, indicates a movement of the figure displayed by indicating a movement direction.

Advantageously, the imaging apparatus comprises an inside area image display device that distinctly displays on a monitoring screen an inside cut-out area image from other images when recording the image data.

A second aspect of the present invention relates to a method of recording image data of an imaging apparatus including the steps of importing image data via a photoelectrical conversion element of a rectangular light receiving surface; selecting a square cut-out area in which the number of pixels in the horizontal direction is the same as the number of pixels in the vertical direction from the imported image data; cutting out image data from the selected cut-out area; and recording cut-out image data or compressed image data.

Advantageously, a center portion of the image imported by the photoelectrical conversion element is automatically cut out.

Advantageously, a figure that displays the cut-out area is superimposed to be displayed on the photographed before recording image screen or the before photographing monitoring screen when selecting the cut-out area and is moved to specify the cut-out area.

### BRIEF DESCRIPTION OF THE DRAWINGS

These and other features, aspects, and advantages of the present invention will become better understood with regard to the following description, appended claims, and accompanying drawings.

FIG. 1 is a block diagram that illustrates the constitution of a digital camera according to an embodiment of the present invention.

FIG. 2 is a diagram that describes the relationship between an imported image and a recorded image according to a first embodiment of the present invention.

FIG. 3 is flow chart that illustrates the operational flow of a digital camera according to the first embodiment of the present invention.

FIG. 4 is a diagram that illustrates a display example of a monitor screen according to the first embodiment of the present invention.

FIG. 5 is a diagram that illustrates a display example of a monitor screen according to a second embodiment of the present invention.

FIG. 6 is a diagram that describes direction indicator keys to move a cut-out area according to the second embodiment of the present invention.

FIG. 7 is a flow chart that illustrates the operational flow of a digital camera according to the second embodiment of the present invention.

FIG. 8 is a flow chart that illustrates the operational flow of a digital camera according to a third embodiment of the present invention.

FIG. 9 is a diagram that illustrates a display example of a monitor screen according to a fourth embodiment of the present invention.

FIG. 10 is a diagram that describes the issues of the present invention.

### DETAILED DESCRIPTION OF THE INVENTION

The preferred embodiments of the present invention are described in detail with reference to the drawings hereinbelow. However, the constituent parts, type, combination, shape and the relative positions described by the present embodiment are not thought to be limited to only the scope of the descriptions unless there is a specific notation, but are only descriptive examples.

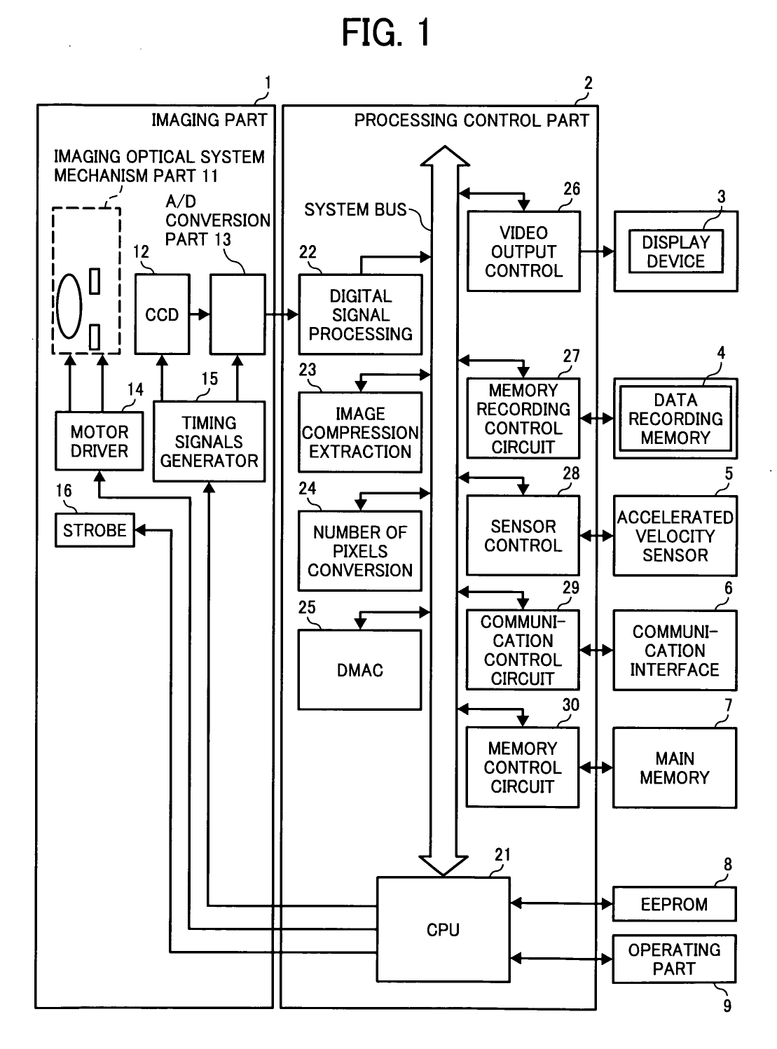

FIG. 1 is a block diagram that illustrates the constitution of a digital camera as an embodiment of the present invention. As shown in the figure, the digital camera includes an image photographing part 1, a processing control part 2, a display device (for example, a liquid crystal display) 3 that displays the playback image or the monitor image of a subject before photographing (before the shutter button is pushed), a detachable data recording memory (for example, a memory card) 4 that records the image data of a photographed image, an accelerated velocity sensor 5, a communications interface 6, a main memory (for example, a RAM) 7 that temporarily stores various types of data such as image data, an EEPROM 8 written with a program or fixed data or the like and an operation part 9.

In addition, the imaging part 1 includes an imaging optical system mechanism part 11 that includes a lens, a shutter and the like, a CCD (charge-coupled device) 12 that is a photoelectrical conversion element which converts the optical signals from the subject inputted into a rectangular light receiving surface via the optical imaging system mechanism part 11 into electrical analog image signals, an A/D conversion part 13 that converts the analog image signals outputted from the CCD 12 into image data of digital values, a motor driver 14 that rotates a motor which drives the shutter or the like in the optical imaging system mechanism part 11, a timing signal generation part 15 that generates timing signals to be provided for the CCD 12 and the A/D conversion part 13, and a strobo 16.

In addition, the processing control part 2 includes a CPU 21 that controls the digital camera in its entirety, a digital signal processing part 22 that converts the image data of digital value outputted from the A/D conversion part 13 into image data of a determined data format, an image compression extraction part 23 that compresses the image data or extracts the compressed image data into the original data, a number of pixels conversion part 24 that increases and decreases the number of pixels that constitute an image to change the image size or cut out image data of the number of pixels in a designated lengthwise and breadthwise direction from a designated position, a DMA controller (DMAC) 25 for high speed memory data forwarding, a video output control part 26 to display the generated display data on the display device 3, a recording memory control circuit 27 that performs reading and writing or the like of data relative to the data recording memory 4, a sensor control circuit 28 that obtains the accelerated velocity detected by controlling the accelerated velocity sensor 5, a communication control part 29 that performs communication in-between an external device by controlling the communication interface 6, and a memory control circuit 30 that performs reading and writing of data relative to the main memory 7.

Regarding such a constitution, in the image photographing part 1, the motor driver 14 operates a mechanism part 11 of the optical image photographing system by the directions from the CPU 21, and the A/D conversion part 13 converts the analog image signals obtained from the CCD 12 into the image data of digital values and passes on the converted image data to the processing control part 2.

In the processing control part 2, relative to the image data obtained from the image photographing part 1, the digital signal processing part 22 generates image data of RGB or YUV format as needed. The image compression extraction part 23 generates image data for recording after performing the compression of image data. A memory card or the like as the data recording memory 4 records the image data for recording. In addition, the display device 3 displays the photographed image or information with regard to the photographing or the like.

Each embodiment of the present invention is described hereinbelow. Moreover, in each embodiment, an image is cut out and a cut-out image is obtained by the number of pixels conversion part 24. The image is recorded by the CPU 21 and the recording memory control circuit 27

### Embodiment 1

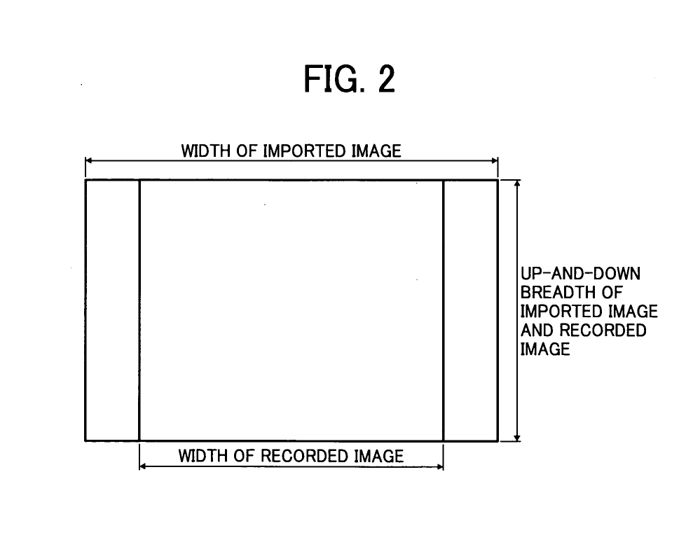

FIG. 2 is a diagram that illustrates the relationship between an image imported from the CCD 12 which is a photoelectrical conversion element and a recording image. As illustrated in the figure, the horizontal width of the imported image is longer than the vertical length (up-and-down breadth) of the imported image. Therefore, in the present embodiment, with regard to the horizontal direction (right and left direction) of the imported image, only an image at the center portion with the same number of pixels as the vertical length is automatically cut out, so that the cut-out square image can be recorded.

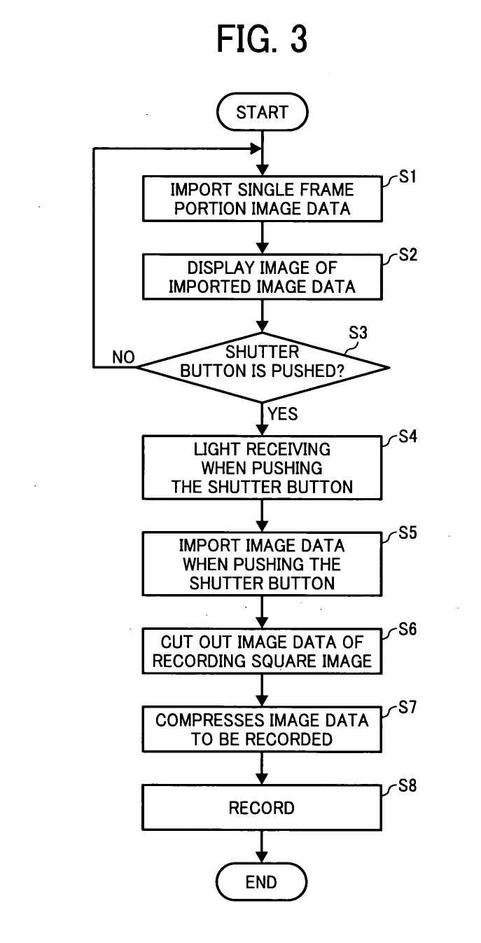

Next, the processing flow of the embodiment is described. FIG. 3 is a flow chart that illustrates the operation of the digital camera according to the present embodiment.

First, at the monitoring stage before photographing (before the shutter button is pushed), the CPU 21 imports image data corresponding to a single frame portion from the CCD 12 to the main memory 7 (step S1). The CPU 21 displays the image of the image data onto the display device 3 (step S2). This operation is repeated until a shutter button is pushed, (if determined No at the processing of step S3 step S1 step S2). The number of pixels of the image data in the vertical direction and the horizontal direction is the number of pixels of the light receiving surface of the CCD 12 in the vertical direction and the horizontal direction. In so doing, when receiving the orders from the CPU 21, the timing signals generation part 15 generates readout timing signals such as readout clock signals, and also performs the elimination of the data (electrical charge) stored in the CCD 12 at the timing when read-out scanning is finished. The storage time of electrical charges proportional to the light quantity stored in the CCD 12 is the time from the immediate completion of the elimination timing to the next read-out.

Next, when the shutter button is pushed (step S3/Yes), the light is received in only the storage time determined based on the monitoring results, the electrical charges proportional to the light quantity are accumulated in the CCD 12 (step S4), and the CPU 21 imports the image data output from the CCD 12 into the main memory 7 (step S5). The CPU 21 then passes the image data in sequence from the first line to the number of pixels conversion part 24. The number of pixels conversion part 24 repeats cut-out processing to cut out image data of only the preliminarily given number of pixels portion from the line center portion image data received from line to line. The processing is repeated by only the number of line portions. (The number of lines is equal to the number of pixels to be cut out from each line.) Thereby, image data of a square area (refer to FIG. 2) at the center of the image is cut out (step S6).

Next, the CPU 21 passes the cut-out image data to the image compression extraction part 23 to be compressed (step S7) and records the compressed image data in the data recording memory 4 (step S8).

Hereby, according to the present embodiment, using a general digital camera having a rectangular light receiving surface, the square image at the center portion of the rectangular light receiving surface can be automatically cut out and recorded.

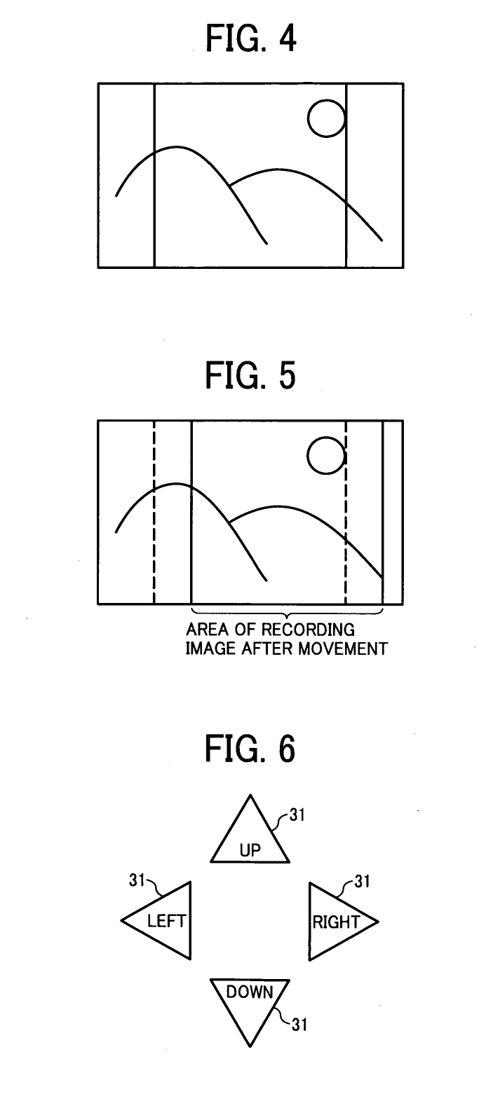

In addition, when monitoring, it is also possible to display a square frame or two vertical lines that illustrate the cut-out area at the center portion. The display example is illustrated in FIG. 4. The example shown in FIG. 4 illustrates the two right and left vertical lines by the solid lines, but a dotted line or the like is also possible. Thereby, the user can easily recognize the area to be recorded.

### Embodiment 2

In embodiment 1, a square image at the center portion that can obtain a high image quality is automatically cut out from a horizontally long image. In embodiment 2, the cut-out area (recording area) can be slightly adjusted in the vicinity of the center part when photographing with a tripod stand. The cut-out area can be moved based on intensions to generate pictures. In addition, regarding the present embodiment, the display of the cut-out area is realized by the CPU 21 and the video output control part 26.

The display example of the present embodiment is illustrated in FIG. 5. In the example, it is designated to record a square image situated closer to the right side from the center portion. In FIG. 5, the area shown by the dotted lines is the image center. For the indication of the cut-out area, the direction indication keys 31 provided on the operating portion 9 as, for example, shown in FIG. 6 are used. The example shown in FIG. 5 corresponds to the case in which “right” is pushed within the direction indication keys 31 shown in FIG. 6. The cut-out area is displaced to the right side and the line or the like that illustrates the cut-out area superimposed with the monitoring image before photographing is displayed on the display device 3. In addition, the digital camera is fixed to a tripod stand or the like. While watching the monitoring image on the display device 3, the user pushes the direction indication keys 31 disposed, for example, on the upper surface of the digital camera.

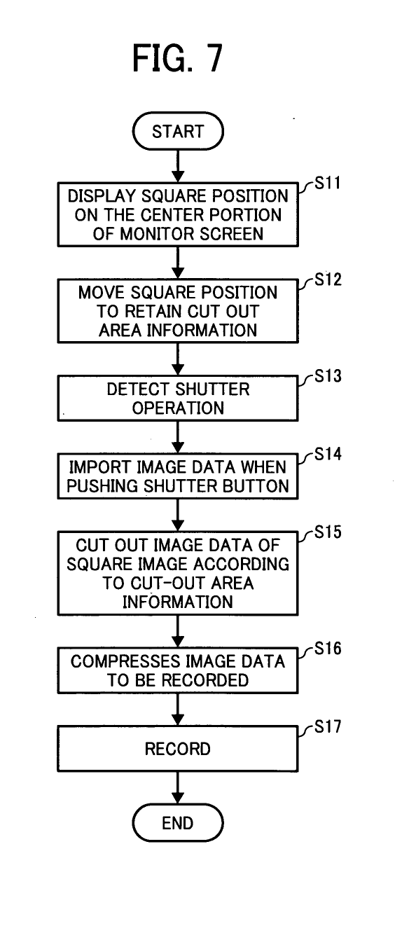

Next, the processing flow of the present embodiment is described. FIG. 7 is a flow chart that illustrates the operation of the digital camera according to the present embodiment.

When monitoring, first, the CPU 21 displays the vertical lines of dotted lines or solid lines on the left side and right side within the monitoring screen to display the square position at the center portion (step S11). Then, for example, when the CPU 21 detects that the right direction indication key is pushed, for the duration of the push, the square position shown by the left and right vertical lines is moved to the right at a predetermined speed (step S12). That is, the operation to display the left and right vertical lines at positions shifted to the right is repeated. The positions are shifted to the right by only a predetermined length and according to predetermined time phases. Alternatively, every time the right direction indication key is pushed instantaneously, the left and right vertical lines shifted to the right by only the predetermined length can be displayed.

In addition, the example shown in FIG. 5 is a case wherein the vertical length of the cut-out area matches the vertical length of the display image (imported image). It is also possible to let the user preliminarily specify the ratio of the vertical length of the cut-out area relative to the vertical length of the display image. In this case, when monitoring, the CPU 21 displays the square frame on the center of the screen. That is to say, the square frame is displayed so that it occupies the center not only in the right-left direction but also in the up-and-down direction. When detecting the pushing of, for example, the up direction indication key (refer to FIG. 6), the display frame of the square frame is moved up as stated above. In addition, the CPU 21 stores for example the line numbers of four comers and the pixel number in a predetermined region of the main memory 7 as the updated cut-out area information every time the cut-out area is moved.

When a shutter button is pushed in this state, the CPU 21 detects the action (step S13). Similar to embodiment 1, the input image at the moment is imported by the CPU 21 into the main memory 7 (step S14). Then the stored cut-out area information is passed to the number of pixels conversion part 24 and the image data imported to the main memory 7 is further passed to the number of pixels conversion part 24 in units of one line. The number of pixels conversion part 24 thereby cuts out the image data from line to line based on the cut-out area information (Step S15).

Next, the CPU 21 passes the cut-out image data to the image compression extraction part 23 to be compressed (step S16) and records the compressed image data in the data recording memory 4 (step S17).

According to the present embodiment, a square image can be cut out from an intended position of an imported rectangular image, and the cut-out image can be recorded.

### Embodiment 3

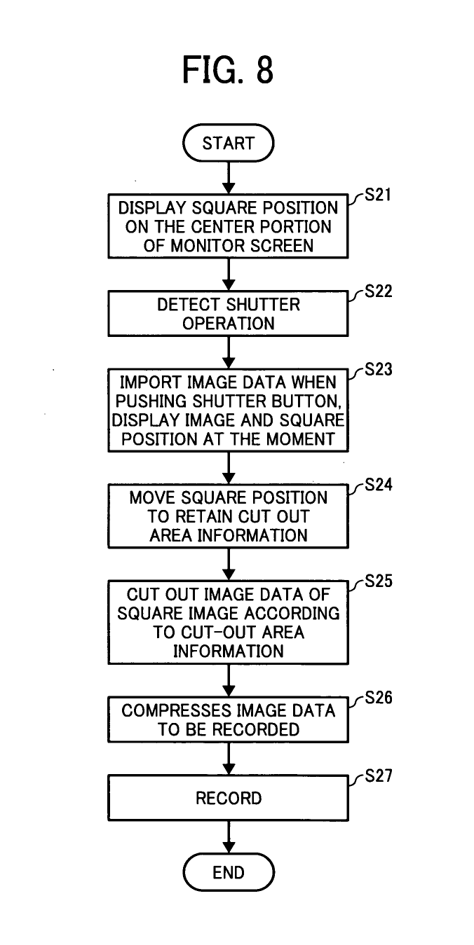

Embodiment 3 is an example of cutting out a recording image by specifying a cut-out area after pushing the shutter button. FIG. 8 is a diagram that illustrates the operational flow of the embodiment 3. The processing flow is described with reference to FIG. 8.

When monitoring, first, the CPU 21 displays the square position at the center portion by displaying vertical lines of dotted lines or solid lines on the right and left (step S21). When the shutter button is pushed in this state, the CPU 21 detects the action (step S22), imports the CCD output image data at that moment to the main memory 7 in the same way as embodiment 1, and displays the image of the imported image data and the square position to the screen center portion (step 23).

Thereafter, by detecting that the direction indication keys are pushed, the vertical lines on the right and left are moved at the same speed to the indicated direction in the same way as embodiment 2 (step S24). In addition, it is also possible to let the user preliminarily specify the ratio of the vertical length of the cut-out area relative to the vertical length of the imported image. In this case, the square frame is displayed on the center of the screen. Then, by detecting the pushing of, for example, the up or down direction indication key (refer to FIG. 6), the square display frame is moved in the indicated up or down direction. The CPU 21 stores the line numbers of four corners and the pixel number in the predetermined region of the main memory 7 as the cut-out area information updated every time the cut-out area is moved.

Thereafter the CPU 21 passes the cut-out area information to the number of pixels conversion part 24, and further passes the image data imported into the main memory 7 to the number of pixels conversion part 24 in units of one line. The number of pixels conversion part 24 then cuts out the image data from line to line based on the cut-out area information (step S25).

Next, the CPU 21 passes the cut-out image data to the image compression extraction part 23 to be compressed (step S26), and records the compressed image data in the data recording memory 4 (step S27).

According to the present embodiment, the cut-out area to be recorded can be easily specified even in the case of not using a tripod stand.

### Embodiment 4

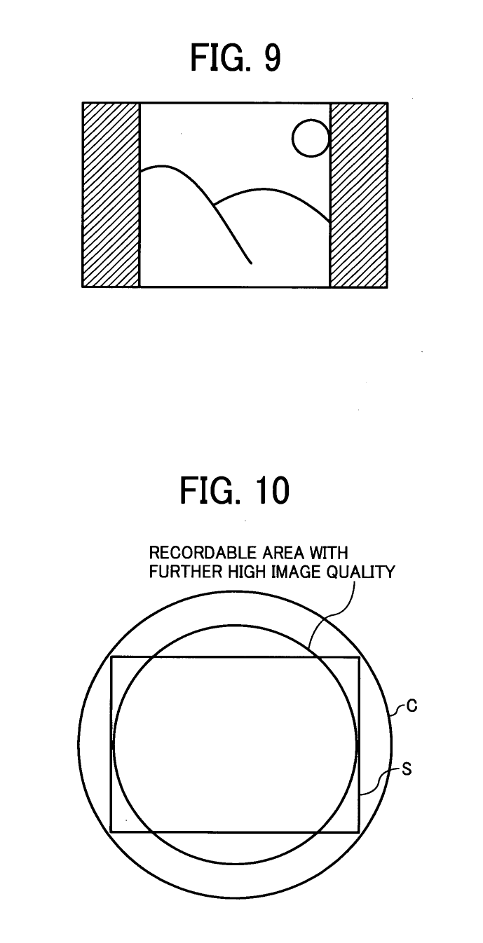

The embodiment is an example of distinctly displaying the image of an area to be recorded from other images. As shown in FIG. 9, the outside area images not to be recorded are filled out with black or the like on the display screen. Instead of turning the luminance to 0, the outside area images can be displayed by lowering the contrast. Thereby, the user can further easily recognize the area to be recorded.

According to the embodiments of present invention, a widely spread imaging apparatus with a photoelectrical conversion element of a rectangular light receiving surface can automatically cut out a square image from the center portion of the imported rectangular image. Consequently, the imaging apparatus can easily cut out and record the square image. In addition, such an imaging apparatus can specify the position of the square image to be cut out, and can cut out and record a square image of an intended position.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An imaging apparatus, comprising:
a photoelectrical conversion element with a rectangular light receiving surface;
an image cut-out device that cuts out image data of a cut-out area of a square in which the number of pixels in the horizontal direction is the same as the number of pixels in the vertical direction from image data of a rectangular image imported by the photoelectrical conversion element; and
an image recording device which records image data compressed by an image compression device or the image data cut out by the image cut-out device.

2. An imaging apparatus according to claim 1, wherein the image cut-out device automatically cuts out a center portion of an image imported by the photoelectrical conversion element.

3. An imaging apparatus according to claim 1, further comprising an area selection device that selects the cut-out area.

4. An imaging apparatus according to claim 3, further comprising a cut-out area display device which, as the area selection device, superimposedly displays a figure illustrating the cut-out area on a screen of a photographed image before recording or a monitoring screen before photographing when selecting the cut-out area.

5. An imaging apparatus according to claim 4, further comprising a movement indication device which, as the area selection device, indicates a movement of the figure displayed by indicating a movement direction.

6. An imaging apparatus according to claim 2, further comprising:
an inside area image display device which distinctly displays on a monitoring screen an inside cut-out area image from other images when recording the image data.

7. An imaging apparatus according to claim 3, further comprising:
an inside area image display device which distinctly displays on the monitoring screen an inside cut-out area image from other images when recording the image data.

8. A method of recording image data of an imaging apparatus, comprising the steps of:
importing image data via a photoelectrical conversion element of a rectangular light receiving surface;
selecting a square cut-out area in which the number of pixels in the horizontal direction is the same as the number of pixels in the vertical direction from the imported image data;
cutting out image data from the selected cut-out area, and;
recording cut-out image data or compressed image data.

9. A method of recording image data of an imaging apparatus according to claim 8, wherein a center portion of the image imported by the photoelectrical conversion element is automatically cut out.

10. A method of recording image data of an imaging apparatus according to claim 8, wherein a figure that displays the cut-out area is superimposed to be displayed on the photographed before recording image screen or the before photographing monitoring screen when selecting the cut-out area and is moved to specify the cut-out area.
